(19) United States
(12) Patent Application Publication
(10) Pub. No.: US 2012/0304073 A1
(43) Pub. Date: Nov. 29, 2012

(54) Web Browser with Quick Site Access User Interface

(76) Inventors: Mirko Mandic, Seattle, WA (US); Alexandra M. Feldman, Seattle, WA (US); Jane T. Kim, Seattle, WA (US); Aaron M. Butcher, Redmond, WA (US); Rodger W. Benson, Seattle, WA (US); Zachary J. Shallcross, Bothell, WA (US); Jonathan R. Christen, Redmond, WA (US); Joon K. Chang, Seattle, WA (US); Eli B. Goldberg, Seattle, WA (US); Mary-Lynne Williams, Seattle, WA (US); Jess S. Holbrook, Seattle, WA (US); Lindsey R. Barcheck, Seattle, WA (US)

(21) Appl. No.: 13/117,893

(22) Filed: May 27, 2011

(51) Int. Cl. G06F 3/01

(52) U.S. Cl. 715/745

(57) ABSTRACT

Various embodiments provide a unified and organized Web browser navigational experience that draws potential navigable pages from multiple different sources and presents the pages in an easily-explorable user interface. Presentation of these potentially navigable pages occurs automatically, in a contextually relevant manner, based upon an implied user intent to navigate away from a current page.

### BACKGROUND

Current web browsers offer numerous, disconnected pieces of user interface that help users navigate away from the page that they are currently on. For example, users can engage the address bar, new tab page, favorites menu, history menu, and the like to achieve the same underlying goal—to navigate to some other page. These disconnected browser mechanisms do not provide as efficient a navigation experience as would be desirable in many instances.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments provide a unified and organized Web browser navigational experience that draws potential navigable pages from multiple different sources and presents the pages in an easily-explorable user interface. Presentation of these potentially navigable pages occurs automatically, in a contextually relevant manner, based upon an implied user intent to navigate away from a current page.

In one or more embodiments, responsive to a user indicating an intent to navigate away from a current page, the Web browser provides an immersive, full-screen experience that presents pages or sites to which the user may wish to navigate. Presented pages or sites can be drawn from multiple different sources including those based on the user's browsing habits, chronology, and expectations. In one or more embodiments, an intent to navigate away from a current page can be implied from one or more user actions including, by way of example and not limitation, placing focus on the address bar.

In one or more embodiments, when focus is placed on the address bar, the Web browser transitions from a browsing-centric view into a view that presents pages or sites that are drawn from the multiple different sources. In at least some embodiments, as a user types in the address bar, matching logic presents pages or sites that match, in some way, text that is entered by the user.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing FIG. 1 in greater detail.

FIG. 3 illustrates an example computing device in accordance with one or more embodiments.

FIG. 4 illustrates an example computing device in accordance with one or more embodiments.

FIG. 5 illustrates an example computing device in accordance with one or more embodiments.

FIG. 6 is a flow diagram that describes steps in a method in accordance with one or more embodiments.

FIG. 7 illustrates an example computing device in accordance with one or more embodiments.

FIG. 8 illustrates an example computing device in accordance with one or more embodiments.

FIG. 9 is a flow diagram that describes steps in a method in accordance with one or more embodiments.

FIG. 10 illustrates an example computing device that can be utilized to implement various embodiments described herein.

### DETAILED DESCRIPTION

### Overview

Various embodiments provide a unified and organized Web browser navigational experience that draws potential navigable pages from multiple different sources and presents the pages in an easily-explorable user interface. Presentation of these potentially navigable pages occurs automatically, in a contextually relevant manner, based upon an implied user intent to navigate away from a current page.

In one or more embodiments, responsive to a user indicating an intent to navigate away from a current page, the Web browser provides an immersive, full-screen experience that presents pages or sites to which the user may wish to navigate. Presented pages or sites can be drawn from multiple different sources including those based on the user's browsing habits (e.g., most frequently visited sites), chronology (e.g., history, typed URLs, and the like), and expectations (e.g., sites that have been saved). In one or more embodiments, an intent to navigate away from a current page can be implied from one or more user actions including, by way of example and not limitation, placing focus on the address bar.

In one or more embodiments, when focus is placed on the address bar, the Web browser transitions from a browsing-centric view into a view that presents pages or sites that are drawn from the multiple different sources. In at least some embodiments, as a user types in the address bar, matching logic presents pages or sites that match, in some way, text that is entered by the user.

In the following discussion, an example environment is first described that is operable to employ the techniques described herein. Example illustrations of the navigation user interface are then described, which may be employed in the example environment, as well as in other environments. Next, a section entitled “Persistence Model” describes an example persistence model in accordance with one or more embodiments. Following this, a section entitled “Interacting with the Website Access Area” describes different manners in which a user can interact with the website access area in accordance with one or more embodiments. Last, a section entitled “Example Device” describes aspects of an example device that can be utilized to implement one or more embodiments.

### Example Environment

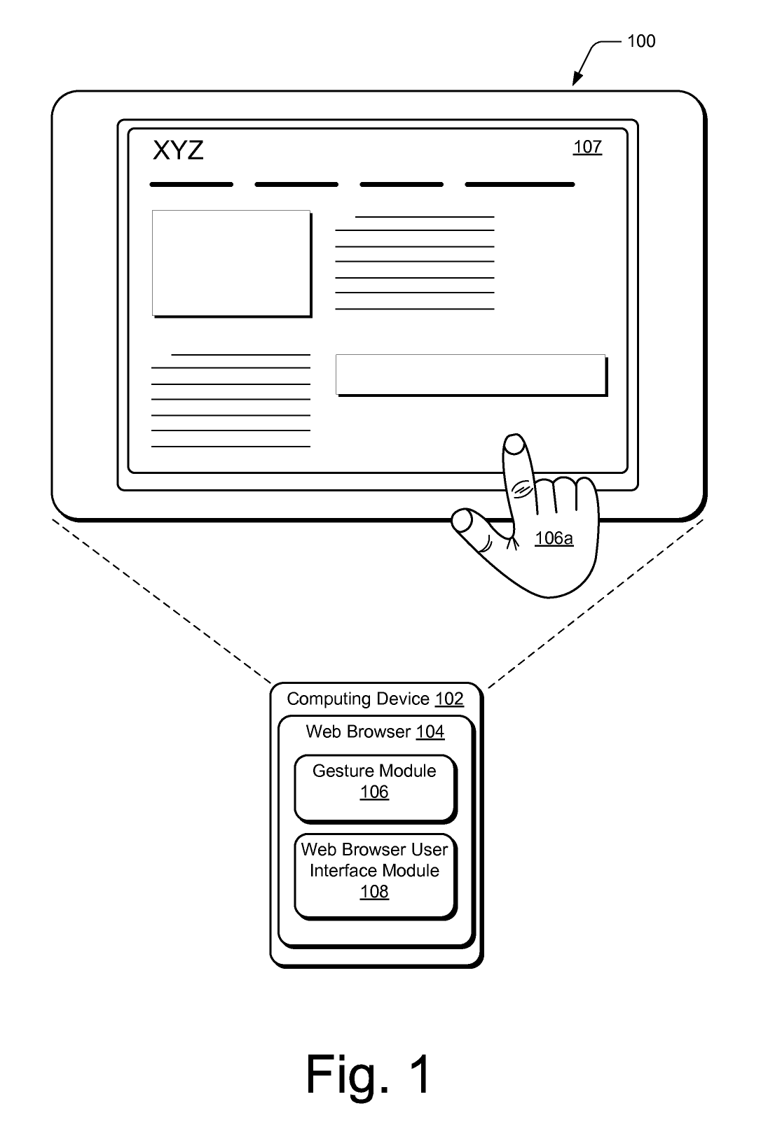

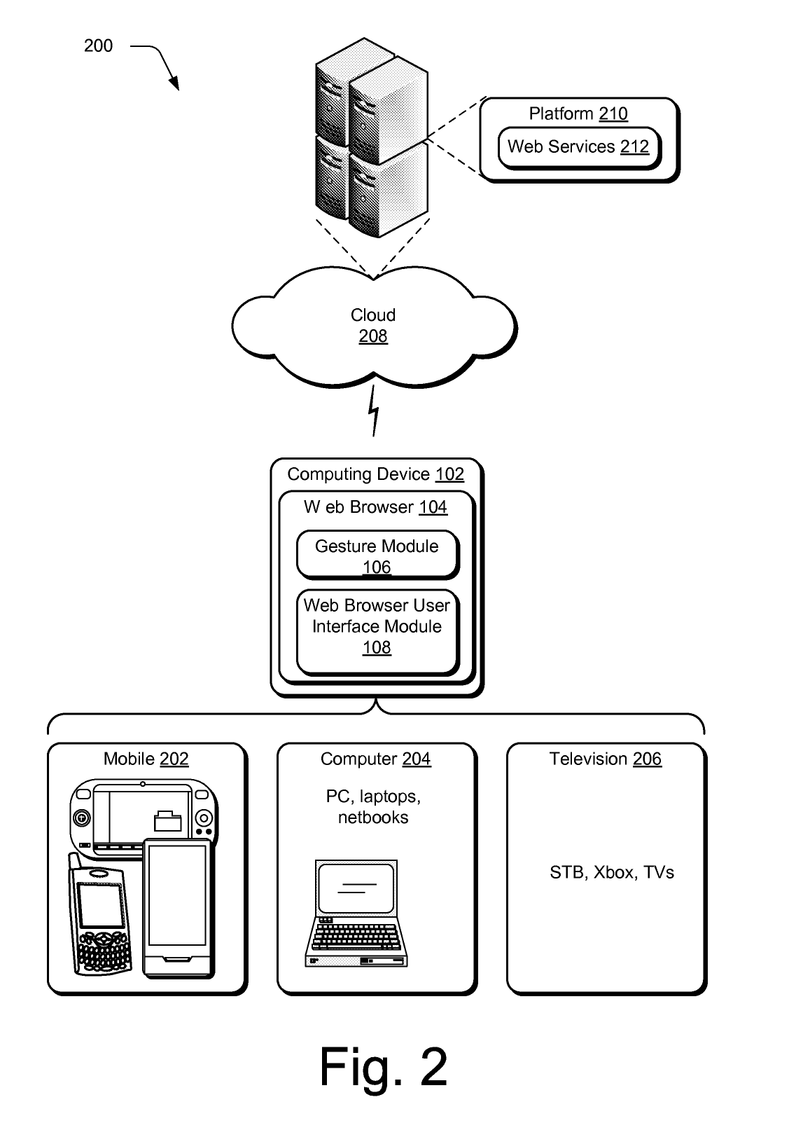

FIG. 1 is an illustration of an environment 100 in an example implementation that is operable to employ the browsing techniques as described herein. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. In one or more embodiments, the computing device is embodied as a slate-type or tablet-type form factor device that can typically be held by a user in one hand, and interacted with using the other hand.

Thus, the computing device 102 may range from full resource devices with substantial memory and processor resources (e.g., personal computers, game consoles, slate or tablet-form factor device) to a low-resource device with limited memory and/or processing resources (e.g., traditional set-top boxes, hand-held game consoles). The computing device 102 also includes software that causes the computing device 102 to perform one or more operations as described below.

Computing device 102 includes a web browser 104 that is operational to provide web browsing functionality as described in this document. The web browser can be implemented in connection with any suitable type of hardware, software, firmware or combination thereof. In at least some embodiments, the web browser is implemented in software that resides on some type of tangible, computer-readable medium examples of which are provided below.

Web browser 104 includes or otherwise makes use of, in this example, a gesture module 106 and a web browser user interface module 108.

Gesture module 106 is representative of functionality that can recognize a wide variety of gestures that can be employed in connection with web browsing activities. In at least some embodiments, one or more gestures can be employed in connection with invocation and dismissal of navigation instrumentalities. For example, a swipe gesture from the bottom of the computing device onto display device 107 can cause presentation of an address bar and other instrumentalities. Likewise, repeating the gesture or performing the opposite gesture can cause dismissal of the address bar and the other instrumentalities.

Gestures may be recognized by module 106 in a variety of different ways. For example, the gesture module 106 may be configured to recognize a touch input, such as a finger of a user's hand 106a as proximal to display device 107 of the computing device 102 using touch screen functionality. Alternately or additionally, the computing device 102 may be configured to detect and differentiate between a touch input (e.g., provided by one or more fingers of the user's hand 106a) and a stylus input provided by a stylus. The differentiation may be performed in a variety of ways, such as by detecting an amount of the display device 107 that is contacted by the finger of the user's hand 106a versus an amount of the display device 107 that is contacted by the stylus.

Thus, the gesture module 106 may support a variety of different gesture techniques through recognition and leverage of a division between stylus and touch inputs, as well as different types of touch inputs.

The web browser user interface module 108 is configured to provide a web browser user interface that permits users to become more fully immersed in web page content that is displayed by the web browser. More specifically, various embodiments provide a unified and organized Web browser navigational experience that draws potential navigable pages from multiple different sources and presents the pages in an easily-explorable user interface, described in more detail below. Presentation of these potentially navigable pages occurs automatically, in a contextually relevant manner, based upon an implied user intent to navigate away from a current page.

In one or more embodiments, responsive to a user indicating an intent to navigate away from a current page, the Web browser 104 provides an immersive, full-screen experience, via web browser user interface module 108 that presents pages or sites to which the user may wish to navigate. Presented pages or sites can be drawn from multiple different sources based on the user's browsing habits (e.g., most frequently visited sites), chronology (e.g., history, typed URLs, and the like), and expectations (e.g., sites that have been saved). In one or more embodiments, an intent to navigate away from a current page can be implied from one or more user actions including, by way of example and not limitation, placing focus on the address bar.

In one or more embodiments, when focus is placed on the address bar, the Web browser transitions from a browsing-centric view into a view that presents pages or sites that are drawn from the multiple different sources. In at least some embodiments, as a user types in the address bar, matching logic presents pages or sites that match, in some way, text that is entered by the user.

FIG. 2 illustrates an example system 200 showing the web browser 104 as being implemented in an environment where multiple devices are interconnected through a central computing device. The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the computing device 102 may be configured in a variety of different ways, such as for mobile 202, computer 204, and television 206 uses.

Each of these configurations has a generally corresponding screen size or form factor and thus the computing device 102 may be configured as one of these device classes in this example system 200. For instance, the computing device 102 may assume the mobile 202 class of device which includes mobile telephones, music players, game devices, slate-type or tablet-type form factor devices and so on. The computing device 102 may also assume a computer 204 class of device that includes personal computers, laptop computers, netbooks, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on.

Thus, the cloud 208 is included as a part of the strategy that pertains to software and hardware resources that are made available to the computing device 102 via the Internet or other networks.

The gesture techniques supported by the gesture module 106 may be detected using touch screen functionality in the mobile configuration 202, track pad functionality of the computer 204 configuration, detected by a camera as part of support of a natural user interface (NUI) that does not involve contact with a specific input device, and so on. Further, performance of the operations to detect and recognize the inputs to identify a particular gesture may be distributed throughout the system 200, such as by the computing device 102 and/or the web services 212 supported by the platform 210 of the cloud 208.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

Having considered example environments in which the various embodiments can be employed, consider now a persistence model in accordance with one or more embodiments.

### Persistence Model

As noted above, various embodiments provide a unified and organized Web browser navigational experience that draws potential navigable pages from multiple different sources and presents the pages in an easily-explorable user interface. Presentation of these potentially navigable pages occurs automatically, in a contextually relevant manner, based upon an implied user intent to navigate away from a current page.

In one or more embodiments, responsive to a user indicating an intent to navigate away from a current page, the Web browser provides an immersive, full-screen experience that presents pages or sites to which the user may wish to navigate. Presented pages or sites can be drawn from multiple different sources based on the user's browsing habits (e.g., most frequently visited sites), chronology (e.g., history, typed URLs, and the like), and expectations (e.g., sites that have been saved). In one or more embodiments, an intent to navigate away from a current page can be implied from one or more user actions including, by way of example and not limitation, placing focus on the address bar.

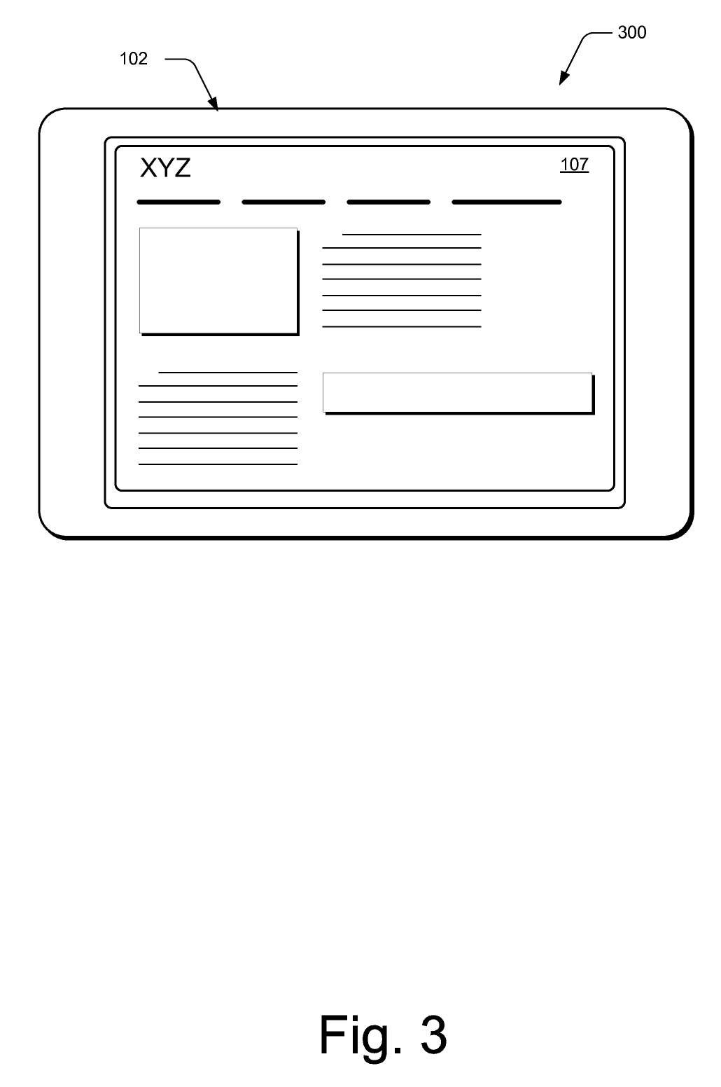

As an example, consider FIG. 3 which illustrates an example environment 300 that includes a computing device 102 having a display device 107. In one or more embodiments, when a webpage is initially loaded, such as the one illustrated in the figure, there are no navigation instrumentalities that are rendered on the display device. Rather, the content of the webpage is presented such that a user is provided a content-focused, edge-to-edge experience where they can focus on the content of the webpage, without their view of the content being obscured by instrumentalities, such as navigation instrumentalities, tab instrumentalities, and the like, that have traditionally been rendered in or around the chrome of the Web browser. Alternately, the browser's navigation bar can be shown on initial loading and on subsequent navigations.

In addition, in one or more embodiments, the navigation instrumentalities as well as other navigation-associated content, such as tabs, can remain in a dismissed stated as a user interacts with the page through activities other than those associated with navigation. For example, a user may scroll or pan through a page's content by, for example, using a mouse or through on-screen gestures respectively. While this takes place, the various navigation and other instrumentalities can remain dismissed, thus providing the user with a content-focused, edge-to-edge experience. It is to be appreciated and understood that the techniques described herein can be employed in scrolling scenarios, as when a user uses their mouse to scroll through content, as well as panning scenarios, as when a user employs a gesture, such as a touch gesture, to pan through content.

In one or more embodiments, various navigation instrumentalities can be invoked, and hence visually presented, in a contextually-relevant manner. The navigation instrumentalities can be presented in any suitable location of the display device, an example of which is provided below. For example, if a user takes an action or performs a task associated with a navigation activity, the navigation instrumentalities as well as other instrumentalities can be invoked and visually presented. As an example, consider the following. Assume that a user is browsing on a particular webpage and selects a link, as by clicking or otherwise touch-tapping on the link. As a consequence, and in view of the fact that the user is conducting a navigation-associated task, navigation instrumentalities as well as other instrumentalities can be visually presented. Specifically, in at least some embodiments, an address bar, and back and forth navigation buttons can be visually presented. Alternately or additionally, navigation instrumentalities can be presented via a gesture, such as a swipe gesture or other gestures.

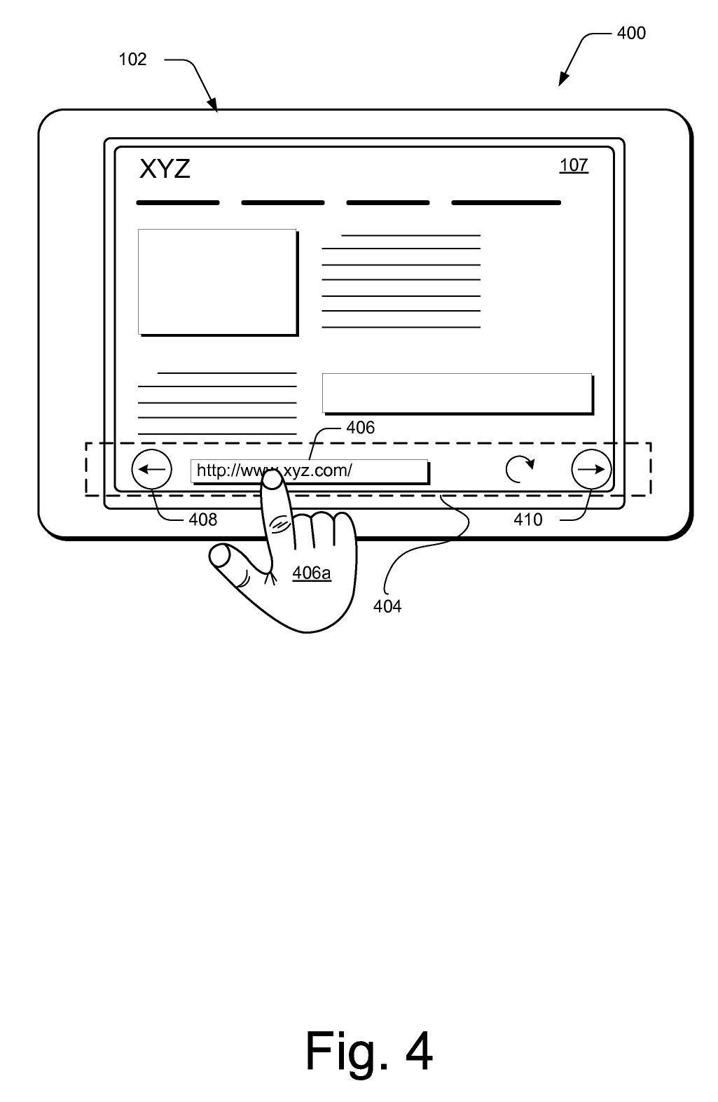

As an example, consider FIG. 4 which illustrates an example environment 400 that includes a computing device 102 in accordance with one or more embodiments. A region 404, indicated by the dashed line at the bottom of display device 107, includes various navigation and other instrumentalities that have been invoked and visually displayed to present a navigation bar. Specifically, in this example, an address bar 406, a backward navigation button 408, and a forward navigation button 410 have been displayed.

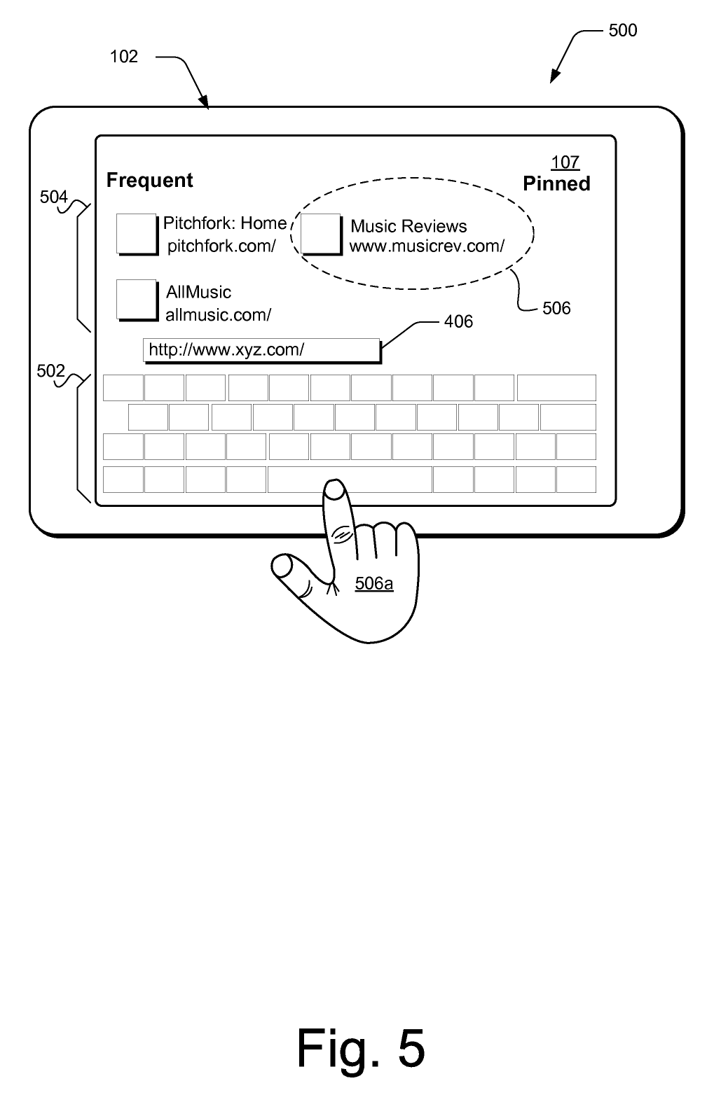

In the present example, a user's hand 406a has placed focus in the address bar 406, as by tapping into the address bar. From this action, an intent to navigate can be implied. Responsive to ascertaining an intent to navigate, the Web browser's user interface can be modified to provide an immersive, full-screen experience that presents pages or sites to which the user may wish to navigate. As noted above, presented pages or sites can be drawn from multiple different sources based on the user's browsing habits (e.g., most frequently visited sites), chronology (e.g., history, typed URLs, and the like), and expectations (e.g., sites that have been saved). As an example, consider FIG. 5.

There, an environment 500 includes computing device 102 having display device 107. In this example, the Web browser's user interface has been modified to include a soft keyboard shown generally at 502 and a website access area 504. In one or more embodiments, the soft keyboard can be presented when a hard keyboard is not detected by the computing device. Interposed between soft keyboard 502 and website access area 504 is address bar 406. Soft keyboard 502 can enable a user to type search terms into address bar 406 as described below.

Website access area 504 constitutes, in this example, a single, unified presentation of websites or pages to which a user may likely wish to navigate. As noted above, presented pages or sites can be drawn from multiple different sources based on the user's browsing habits (e.g., most frequently visited sites, favorites, and the like), chronology (e.g., history, typed URLs, and the like), and expectations (e.g., sites that have been saved). In addition, website access area 504 can include sites that have been pinned to a start menu or other user interface instrumentality.

In the illustrated and described example, the website access area includes the designators “Frequent” and “Pinned” to designate the sources from which the underlying sites or pages originated. In at least some embodiments, website access area 504 is pannable either horizontally or vertically to expose additional sites or pages that occur within.

In this particular example, individual pages or sites that are represented within website access area 504 can be represented both textually and through the use of an icon. As an example, consider the site that appears within region 506. Here, the site is represented by a title “Music Reviews”, a URL that appears just beneath the title, and an icon that appears just to the left of the title and the URL. In this instance, the icon resides in the form of a tile that can have images and colors that are associated with the particular site or page. The image, color or colors of the tile can be extracted or derived from the site by using one or more of the dominant or predominant colors associated with the website, and any images associated with the site. Alternately or additionally, individual websites can provide a so-called favicon that can be utilized as a tile in the representation that appears in website access area 504.

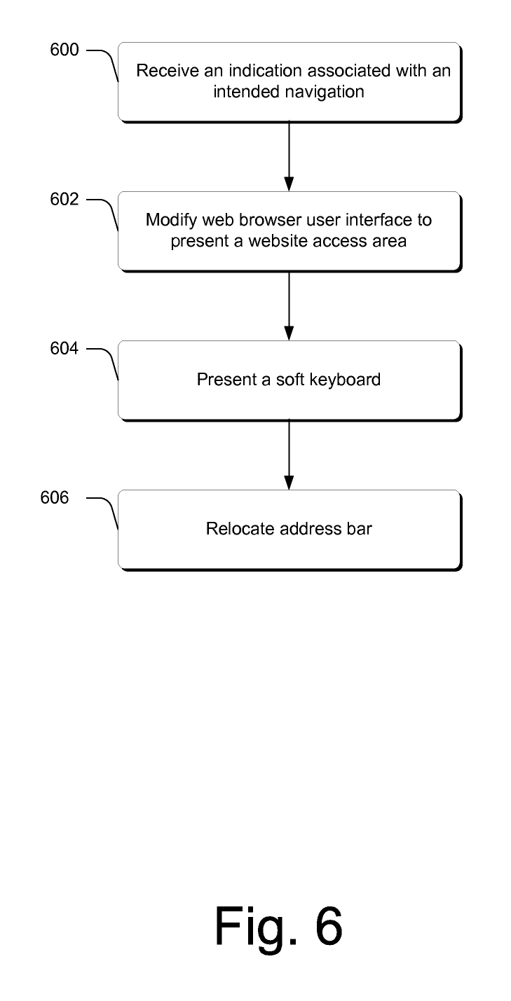

FIG. 6 is a flow diagram that describes steps in a method in accordance with one or more embodiments. The method can be performed in connection with any suitable hardware, software, firmware, or combination thereof. In at least some embodiments, the method can be performed by a suitably-configured web browser, such as the one described above.

Step 600 receives an indication associated with an intended navigation. This step can be performed in any suitable way. For example, in the examples described above, such indication can include, by way of example and not limitation, receiving an indication that focus has been placed on or within a Web browser's address bar. Focus can be placed on or within the address bar in any suitable way such as, but way of example and not limitation, through a mouse gesture, a touch gesture, and the like. It is to be appreciated and understood, however, that indications other than those associated with placing focus on or within the address bar can be utilized without departing from the spirit and scope of the claimed subject matter.

Step 602 modifies the Web browser's user interface to present a website access area. In the illustrated and described embodiment, this step can be performed automatically, responsive to receiving the indication in step 600. Any suitable type of website access area can be utilized, examples of which are provided above. The website access area can present various sites and pages that have been ascertained from a variety of different sources, thus providing a unified, one-stop location that provides navigation options. In one or more embodiments, step 604 can optionally present a soft keyboard to enable a user to input text. An example of how this can be done is provided above. In one or more embodiments, step 606 optionally relocates an address bar. An example of how this can be done is provided above.

Having considered embodiments in which website access area can be presented, consider now various manners in which a user can interact with the website access area.

Interacting with the Website Access Area

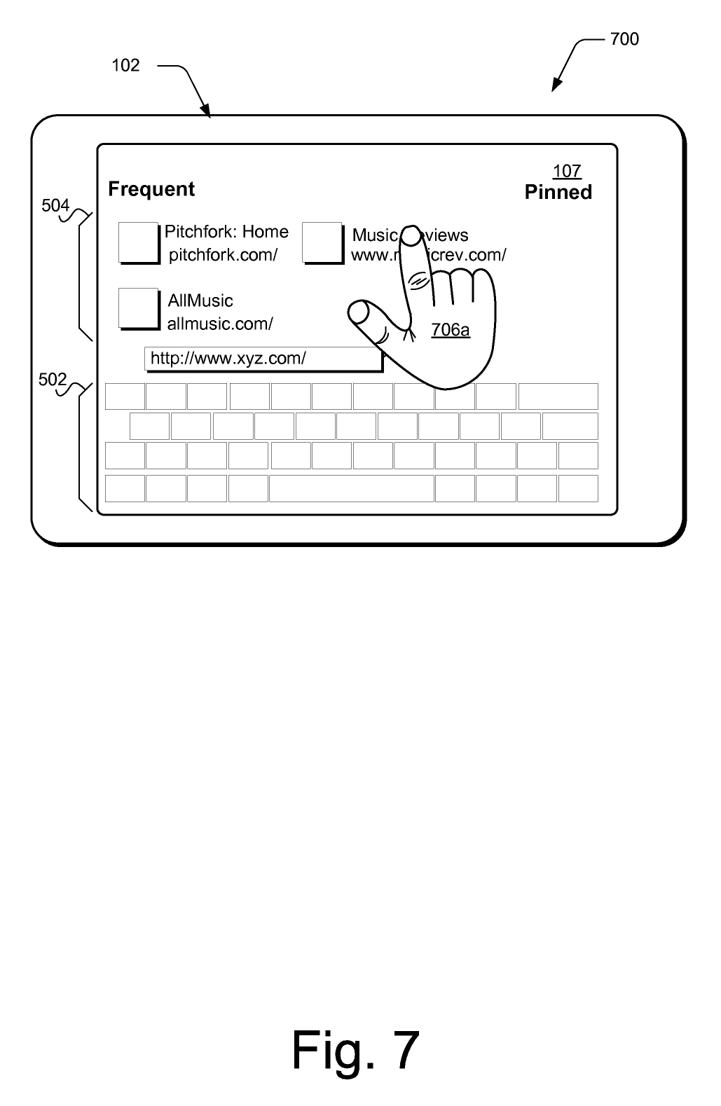

In one or more embodiments, the web browser can enable a user to interact with the website access area in a number of different ways that promote browsing efficiency. As an example, consider FIG. 7 which utilizes numerical designators from earlier-described embodiments to depict like components.

Note first that, as mentioned above, website access area 504 can be pannable to allow user to access various displayed pages or sites that have been ascertained from multiple different sources. Thus, by gesturing left or right, content within the website access area can be panned in a corresponding direction.

Another way in which a user can interact with the website access area 504 is by touch-selecting one of the displayed sites or pages to navigate to that site or page. In the present example, a user's hand 706a has touch-selected the indicated site and, accordingly, will be navigated to that site by the Web browser. In one or more embodiments, navigation to a site can cause dismissal of website access area 504 and presentation of the browser's navigation bar.

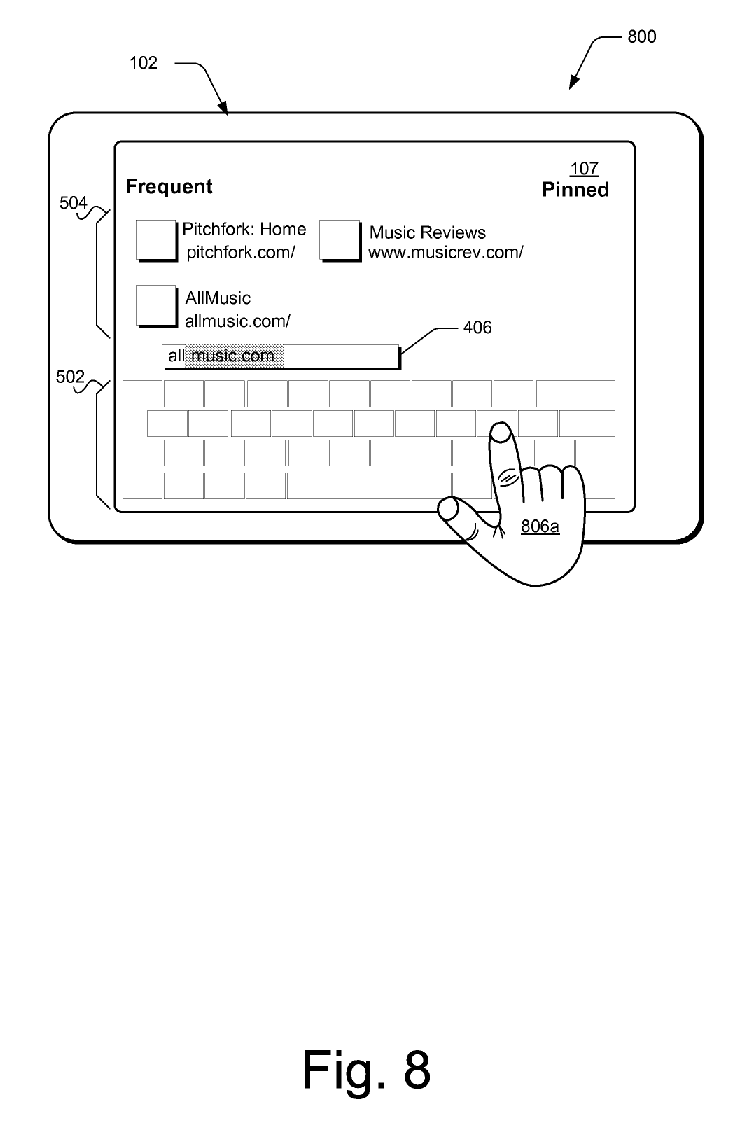

Alternately or additionally, another way in which a user can interact with the website access area is by interacting with the illustrated address bar. Specifically, in this particular example, the address bar can be utilized as a search mechanism to search through and filter sites or pages that appear or otherwise comprise part of the presentation within website access area 504. This can be performed in any suitable way. For example, as a user types text into the address bar, the Web browser can utilize word wheel functionality to filter or otherwise pare down the list of sites or pages that appear within the website access area. As an example, consider FIG. 8.

There, using soft keyboard 502, a user has entered the letters “all” into address bar 406 to perform a search across content that comprises part of the presentation of website access area 504. In one or more embodiments, the address bar 406 can have an auto complete feature which assists the user in entering their search. In this particular example, notice the text “music.com” appears next to the text “all.” This is to signify that the text “music.com” is being provided by the auto complete feature to assist the user. In one or more embodiments, upon completion of text entry in address bar 406, pressing the “enter” key will commit the search and pages or sites that appear or otherwise comprise part of the content of website access area 504 will be filtered on the entered text. Alternately or additionally, filtering can take place automatically after entry of individual letters. When this happens, “Pitchfork: Home” and “Music Reviews” would be automatically removed from the display.

Searching across the sites or pages that appear within the website access area 504 can be conducted in any suitable way. For example, logic within the web browser may look for text matches that appear within a site's title. Alternately or additionally, the Web browser may look for text matches that appear within a site's URL. Alternately or additionally, other various metadata that may be associated with a site or a page can be searched. Further, content within a particular page can be searched as well.

In one or more embodiments, the address bar can be utilized, in conjunction with one or more search providers when, for example, text that is entered therewithin does not result in a match with content that appears in or otherwise comprises part of the website access area 504. So, for example, if a user's entered text does not result in a match, the text can be utilized as the basis of the search that can be performed by one or more search providers, such as a default search provider. Results of the search can be presented by the Web browser in any suitable way. For example, in at least some embodiments, search results can be presented via a search results page that is displayed within display device 107. Alternately or additionally, search results can be displayed in a manner similar to that shown in FIG. 8. In at least some embodiments, search suggestions can be provided in an area adjacent, e.g. above address bar 406. Further, site suggestions for related sites can be provided as well. Such suggestions can be presented in website access area 504 under the title “Suggestions.”

In one or more embodiments, the Web browser can be configured to enable a user to manage and organize the manner in which information is presented in website access area 504. For example, through a suitably-configured menu, a user can modify or define various parameters that are utilized to decide what content to present within website access area 504. For example, a user may define parameters associated with what is considered a frequent site. In addition, a suitably-configured user interface instrumentality can be utilized to enable a user to rearrange, reorder, and/or customize the manner in which information is presented within the website access area 504.

Further interactions can include enabling the user to choose how a particular website is to be opened when selected from the website access area 504. For example, a user may define that a new tab is to be open, a new window is to be opened, and the like.

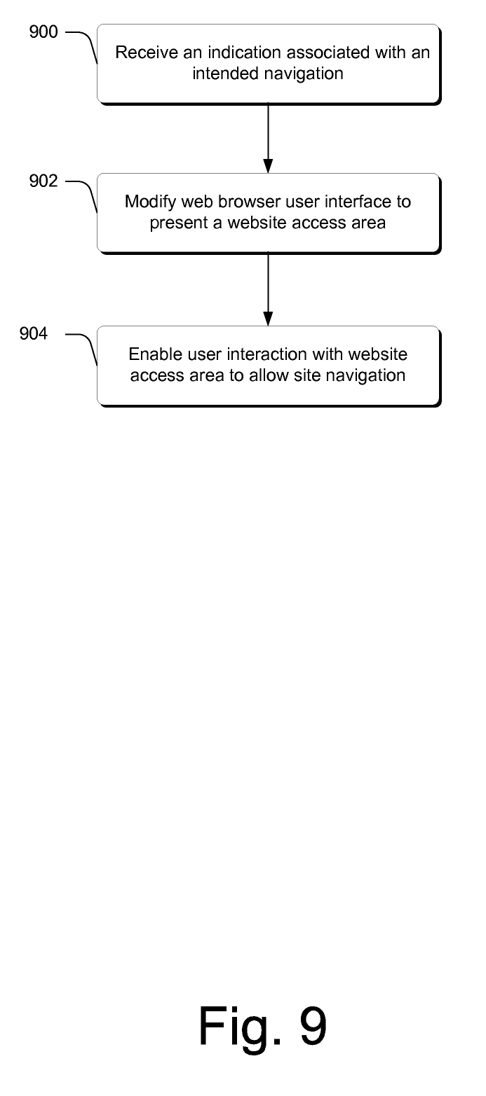

FIG. 9 is a flow diagram that describes steps in a method in accordance with one or more embodiments. The method can be performed in connection with any suitable hardware, software, firmware, or combination thereof. In at least some embodiments, the method can be performed by a suitably-configured web browser, such as the one described above.

Step 900 receives an indication associated with an intended navigation. The step can be performed in any suitable way. For example, in the examples described above, such indication can include, by way of example and not limitation, receiving an indication that focus has been placed on or within a Web browser's address bar. Focus can be placed on or within the address bar in any suitable way such as, by way of example and not limitation, through a mouse gesture, a touch gesture, and the like. It is to be appreciated and understood, however, that indications other than those associated with placing focus on or within the address bar can be utilized without departing from the spirit and scope of the claimed subject matter.

Step 902 modifies the Web browser's user interface to present a website access area. In the illustrated and described embodiment, this step can be performed automatically, responsive to receiving the indication in step 900. Any suitable type of website access area can be utilized, examples of which are provided above. The website access area can present various sites and pages that have been ascertained from a variety of different sources, thus providing a unified, one-stop location that provides navigation options.

Step 904 enables user interaction with the website access area to allow site navigation. Examples of how this can be done are provided above. For example, interactions can include, by way of example and not limitation, panning interactions, site selection interactions, search interactions via the address bar, including search interactions that utilize one or more search providers, management and organization interactions, and the like.

Having described different ways in which a user can interact with the website access area, consider now a discussion of an example device that can be utilized to implement one or more embodiments.

### Example Device

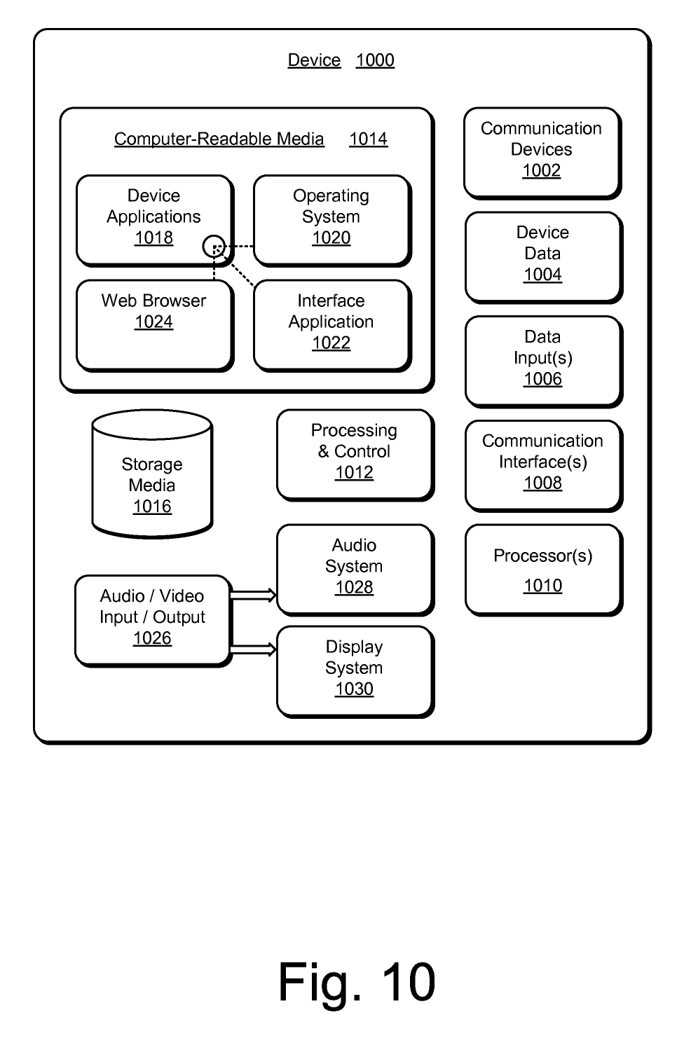

FIG. 10 illustrates various components of an example device 1000 that can be implemented as any type of portable and/or computer device as described with reference to FIGS. 1 and 2 to implement embodiments of the gesture techniques described herein. Device 1000 includes communication devices 1002 that enable wired and/or wireless communication of device data 1004 (e.g., received data, data that is being received, data scheduled for broadcast, data packets of the data, etc.). The device data 1004 or other device content can include configuration settings of the device, media content stored on the device, and/or information associated with a user of the device. Media content stored on device 1000 can include any type of audio, video, and/or image data. Device 1000 includes one or more data inputs 1006 via which any type of data, media content, and/or inputs can be received, such as user-selectable inputs, messages, music, television media content, recorded video content, and any other type of audio, video, and/or image data received from any content and/or data source.

Device 1000 also includes communication interfaces 1008 that can be implemented as any one or more of a serial and/or parallel interface, a wireless interface, any type of network interface, a modem, and as any other type of communication interface. The communication interfaces 1008 provide a connection and/or communication links between device 1000 and a communication network by which other electronic, computing, and communication devices communicate data with device 1000.

Device 1000 includes one or more processors 1010 (e.g., any of microprocessors, controllers, and the like) which process various computer-executable or readable instructions to control the operation of device 1000 and to implement the gesture embodiments described above. Alternatively or in addition, device 1000 can be implemented with any one or combination of hardware, firmware, or fixed logic circuitry that is implemented in connection with processing and control circuits which are generally identified at 1012. Although not shown, device 1000 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1000 also includes computer-readable media 1014, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1000 can also include a mass storage media device 1016.

Computer-readable media 1014 provides data storage mechanisms to store the device data 1004, as well as various device applications 1018 and any other types of information and/or data related to operational aspects of device 1000. For example, an operating system 1020 can be maintained as a computer application with the computer-readable media 1014 and executed on processors 1010. The device applications 1018 can include a device manager (e.g., a control application, software application, signal processing and control module, code that is native to a particular device, a hardware abstraction layer for a particular device, etc.). The device applications 1018 also include any system components or modules to implement embodiments of the gesture techniques described herein. In this example, the device applications 1018 include an interface application 1022 and a web browser 1024 that are shown as software modules and/or computer applications. The web browser 1024 is representative of software that is used to provide web browsing functionality, including an interface with a device configured to capture gestures, such as a touch screen, track pad, camera, and so on.

Device 1000 also includes an audio and/or video input-output system 1026 that provides audio data to an audio system 1028 and/or provides video data to a display system 1030. The audio system 1028 and/or the display system 1030 can include any devices that process, display, and/or otherwise render audio, video, and image data. Video signals and audio signals can be communicated from device 1000 to an audio device and/or to a display device via an RF (radio frequency) link, S-video link, composite video link, component video link, DVI (digital video interface), analog audio connection, or other similar communication link. In an embodiment, the audio system 1028 and/or the display system 1030 are implemented as external components to device 1000. Alternatively, the audio system 1028 and/or the display system 1030 are implemented as integrated components of example device 1000.

### Conclusion

Various embodiments provide a unified and organized Web browser navigational experience that draws potential navigable pages from multiple different sources and presents the pages in an easily-explorable user interface. Presentation of these potentially navigable pages occurs automatically, in a contextually relevant manner, based upon an implied user intent to navigate away from a current page.

In one or more embodiments, responsive to a user indicating an intent to navigate away from a current page, the Web browser provides an immersive, full-screen experience that presents pages or sites to which the user may wish to navigate. Presented pages or sites can be drawn from multiple different sources based on the user's browsing habits, chronology, and expectations. In one or more embodiments, an intent to navigate away from a current page can be implied from one or more user actions including, by way of example and not limitation, placing focus on the address bar.

In one or more embodiments, when focus is placed on the address bar, the Web browser transitions from a browsing-centric view into a view that presents pages or sites that are drawn from the multiple different sources. In at least some embodiments, as a user types in the address bar, matching logic presents pages or sites that match, in some way, text that is entered by the user.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A method comprising:
receiving, via a Web browser, an indication associated with an intended navigation;
responsive to said receiving, automatically modifying a user interface of the web browser to present a website access area, the website access area presenting sites that are drawn from multiple different sources, at least some of which being associated with a user's browsing habits.

2. The method of claim 1, wherein said receiving comprises receiving an indication that focus has been placed on or within an address bar of the Web browser.

3. The method of claim 1, wherein said receiving comprises receiving an indication that focus has been placed on or within an address bar of the Web browser, and wherein receiving an indication comprises receiving a gesture indication.

4. The method of claim 1, wherein the website access area is configured to include one or more pinned sites.

5. The method of claim 1, wherein the website access area includes one or more designators to designate individual sources.

6. The method of claim 1, wherein the website access area is pannable or scrollable.

7. The method of claim 1, wherein the website access area is configured to present sites both textually and through the use of an icon.

8. The method of claim 1, wherein the website access area is configured to present sites both textually and through the use of an icon, and wherein at least some of the icons have a color that is associated with a particular site.

9. The method of claim 1 further comprising presenting a soft keyboard as part of the user interface.

10. The method of claim 1 further comprising relocating an address bar that appears within the user interface.

11. The method of claim 1 further comprising relocating an address bar that appears within the user interface, wherein the address bar is configured to receive text that serves as a basis to conduct a search of sites that are presentable via the website access area.

12. One or more computer readable storage media embodying computer readable instructions which, when executed, implement a method comprising:
receiving, via a Web browser, an indication associated with an intended navigation, wherein said receiving comprises receiving an indication that focus has been placed on or within an address bar of the Web browser;
responsive to said receiving, automatically modifying a user interface of the web browser to present a website access area, the website access area presenting sites that are drawn from multiple different sources; and
enabling user interaction with the website access area to allow site navigation.

13. The one or more computer readable storage media of claim 12, wherein at least some of the sources are associated with a user's browsing habits.

14. The one or more computer readable storage media of claim 12, wherein receiving an indication that focus has been placed on or within the address bar comprises receiving a gesture indication.

15. The one or more computer readable storage media of claim 12, wherein receiving an indication that focus has been placed on or within the address bar comprises receiving a touch gesture indication.

16. The one or more computer readable storage media of claim 12, wherein said enabling comprises enabling touch-selection of a site presented within the website access area.

17. One or more computer-readable storage media embodying computer readable instructions which, when executed, implement a web browser configured to implement a method comprising:
receiving an indication associated with an intended navigation, wherein said receiving comprises receiving an indication that focus has been placed on or within an address bar of the Web browser;
responsive to said receiving, automatically modifying a user interface of the web browser to present a website access area, the website access area presenting sites that are drawn from multiple different sources, wherein presentation of the sites includes, for at least some sites, presenting both textual content and an icon; and
enabling user interaction with the website access area to allow site navigation.

18. The one or more computer-readable storage media of claim 17, wherein the address bar is configured to be utilized as a search mechanism to search through and filter sites that appear or otherwise comprise part of a presentation within the website access area.

19. The one or more computer-readable storage media of claim 17, wherein the address bar is configured to be utilized as a search mechanism to search through and filter sites that appear or otherwise comprise part of a presentation within the website access area, wherein the address bar is configured with an auto-complete feature to assist in text entry.

20. The one or more computer-readable storage media of claim 17, wherein the address bar is configured to be utilized in conjunction with one or more search providers.
